(19) United States
(12) Patent Application Publication
(10) Pub. No.: US 2008/0126656 A1
(43) Pub. Date: May 29, 2008

(54) Silicon storage apparatus and its controller, and operating method thereof

(76) Inventors: Chi-Tung Chang, Taipei (TW); Shih-Min Lan, Taipei (TW); Hungchou Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/524,459

(22) Filed: Sep. 21, 2006

(30) Foreign Application Priority Data
Aug. 8, 2006 (TW) 95128997

(51) Int. Cl. G06F 13/00

(52) U.S. Cl. 710/301

(57) ABSTRACT

A silicon storage apparatus is adapted to a processor base system and comprises a plurality of storage media interfaces and a controller. The storage media interfaces are separately used to contain and connect a storage medium and the controller is electrically connected with the storage media interfaces for providing a data transmission channel to the storage media according to a detecting signal, and outputting an indicating message to the processor base system when another detecting signal produced. Whereby, the sizes of the silicon storage apparatus and the controller can be reduced substantially.

### BACKGROUND OF THE INVENTION

1. Field of the Invention

The invention relates to a silicon storage apparatus, and more particularly a silicon storage apparatus and its controller, and an operating method thereof to share data pins of storage media.

2. Description of the Prior Art

Because various types of the memory cards (silicon storage media) have been developed rapidly in recent years, development of the silicon storage apparatus has more and more mature. The present day, popular silicon storage apparatuses in the market can be divided approximately into internal-type and external-type silicon storage apparatuses. Because various application systems have gradually small size and simple structure, the whole size of no matter the internal-type silicon storage apparatus or the external-type one has became the one of the important considerations for designing and developing so as to be carried conveniently, used commodiously, and save costs.

Reference is shown as in FIG. 1, which is an architecture block diagram of a silicon storage apparatus according to the prior art. A silicon storage apparatus 1′ comprises a controller 10′, a transmission interface 20′, and at least one storage media interface 30′. The storage media interface 30′ is used to contain and connect with a storage medium 3 and the controller 10′ is used to connect with a processor base system 2 by the transmission interface 20′. Because the controller 10′ has to provide separately enough pins of control signals, such as detecting signals 101′, and data signals 102′ to be used by the storage medium 3, the controller 10′ has to be chosen with larger size to support more functions of the plenty storage media 3. Hence, size of the silicon storage apparatus 1‘can’t be further simplified.

Further, because pins of the controller 10′ increase, layout of the printed circuit board is complicated. If the various storage media interfaces 30′ have to be considered of locating and EMI shielding, it is difficult to develop the silicon storage apparatus 1′.

The inventor of the present invention recognizes the above shortage should be improved and special effort has been made to research this field. The present invention is presented with reasonable design to resolve the above problems.

### SUMMARY OF THE INVENTION

The primary object of the present invention is to provide a silicon storage apparatus and its controller, and an operating method thereof to integrate and share data and control buses needed by various storage media by connecting different storage media to switch for using so as to reduce occupied space due to different pins of the various storage media and prevent damage of the data or the storage media because of inserting another storage medium when the silicon storage device reads and writes data to a storage medium.

To achieve the primary objective stated above, a silicon storage apparatus is adapted to a processor base system and comprises a plurality of storage media interfaces and a controller. The storage media interfaces are separately used to contain and connect a storage medium and the controller is electrically connected with the storage media interfaces for providing a data transmission channel to the storage media according to a detecting signal produced by inserting one of the storage media and transmitting data signals by the corresponding storage media interfaces, and outputting an indicating message to the processor base system for processing error status when another detecting signal is produced.

To achieve the primary objective stated above, a controller of the silicon storage apparatus is electrically connected between a processor base system and a plurality of storage media interfaces, the storage media interfaces are separately used to contain and connect a storage medium, and the controller comprises a storage media connecting unit and a micro processing unit. The storage media connecting unit is used to provide a control bus to connect with the storage media interfaces, and further comprises a data pin switching unit used to provide data buses for the storage media operating, and the micro processing unit is used to control the data pin switching unit to switch the data buses to the storage media according a detecting signal produced after inserting one of the storage media into the corresponding storage media interfaces. In addition, the micro processing unit outputs an indicating message to the processor base system for processing error status when another detecting signal is produced.

To achieve the primary objective stated above, an operating method of a silicon storage apparatus is adapted to a processor base system and comprises the steps: connecting a storage medium and switching a data transmission channel to the storage medium; next, determining whether the storage medium being in a reading/writing status or not; next, detecting whether another storage medium being connected to the silicon storage apparatus or not if the storage medium is in a reading/writing status; next, stopping the reading/writing status and outputting an indicating message to the processor base system if another storage medium is connected to the silicon storage apparatus.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is an architecture block diagram of a silicon storage apparatus according to the prior art;

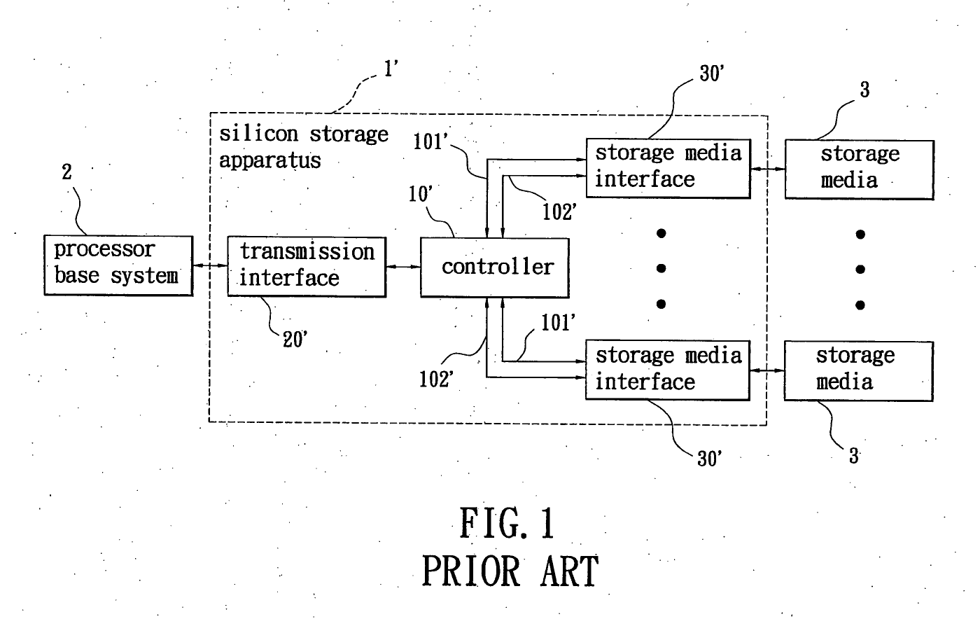

FIG. 2 is an architecture block diagram of an embodiment of a silicon storage apparatus according to the present invention;

FIG. 3 is a block diagram of an embodiment of a controller of the silicon storage apparatus according to the present invention; and

FIG. 4 is a flowchart of an operating method of a silicon storage apparatus according to the present invention.

The drawings will be described further in connection with the following detailed description of the present invention.

### DETAILED DESCRIPTION OF THE PREFERRED EMBODIMENTS

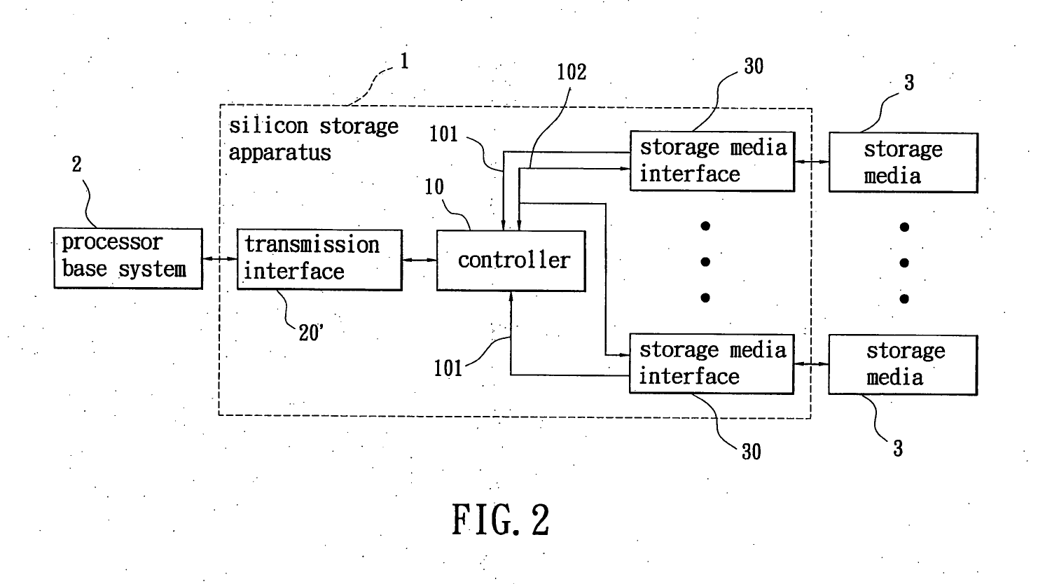

Reference is shown as in FIG. 2 which is an architecture block diagram of an embodiment of a silicon storage apparatus according to the present invention. A silicon storage apparatus 1 is adapted to a processor base system 2 and comprises a controller 10 and a plurality of storage media interfaces 30. The controller 10 is electrically connected with the storage media interfaces 30 and the storage media interfaces 30 are separately used to contain and connect a storage medium 3, and the storage media interfaces 30 can be slot connectors for various memory cards or all-in-one slot connectors and the slot connectors can be chosen according to different types of storage media 3 supported by the silicon storage apparatus 1.

When any storage medium 3 is inserted into the storage media interfaces 30, a detecting signal 101 will be produced to identify existence of the storage medium 3. The controller 10 is electrically connected with the storage media interfaces 30 for providing a data transmission channel to the storage media 3 according to the detecting signal 101 produced by inserting one of the storage media 3 and transmitting data signals 102 by the corresponding storage media interfaces 30. And the controller 10 identifies different detecting signals 101 produced by different storage media 3 to switch automatically the data transmission channel to the corresponding storage media 3. If the processor base system 2 has processed data transmission to a storage medium 3 and the controller 10 also detects another detecting signal 101 produced due to another storage medium 3 being connected with the storage media interfaces 30, the controller 10 will output an indicating message to the processor base system 2. The processor base system 2 builds an application program therein (not shown) to show an error message for the users.

The above-mentioned silicon storage apparatus 1 further comprises a transmission interface 20 electrically connected with the controller 10 and used to transmit data between the silicon storage apparatus 1 and the processor base system 2. In the actual application, the transmission interface 20 can be a USB interface, PC Card interface, PCI interface, PCI-e interface, IEEE 1394 interface, Ethernet interface, IDE interface, SATA interface, SCSI interface, Bluetooth interface, Infrared interface, or etc.

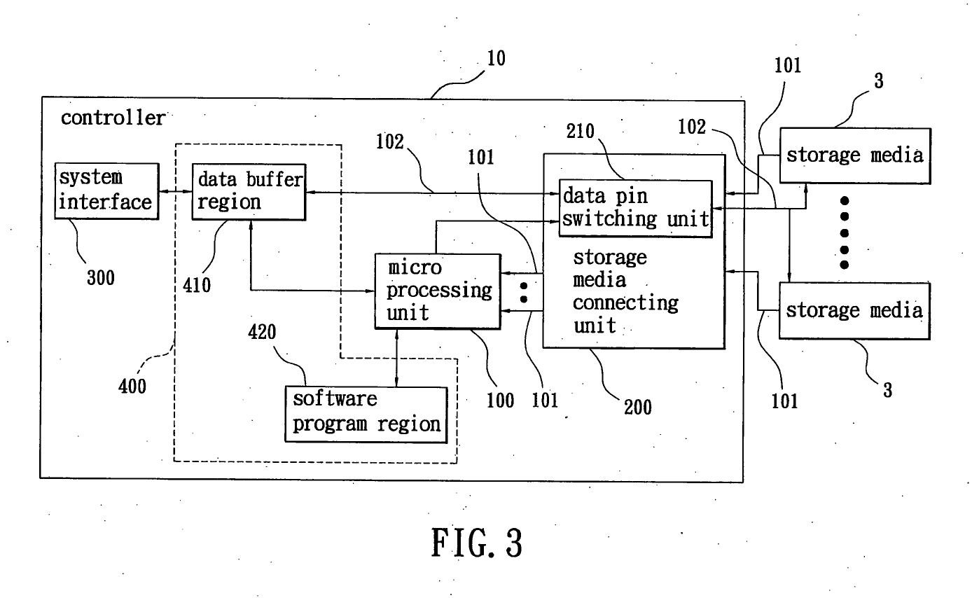

Reference is shown as in FIG. 3 which is a block diagram of an embodiment of a controller of the silicon storage apparatus according to the present invention. A controller 10 of the silicon storage apparatus 1 is electrically connected with a processor base system 2 and a plurality of storage media interfaces 30, and the storage media interfaces 30 are separately used to contain and connect a storage medium 3. The controller 10 comprises a micro processing unit 100 and a storage media connecting unit 200. The storage media connecting unit 200 is used to provide a control bus to connect with the storage media interfaces 30 and further comprises a data pin switching unit 210 is used to provide data buses for transmitting data to different storage media 3. In addition, the data pin switching unit 210 is used to integrate data buses used by all storage media 3 to switch collectively.

The micro processing unit 100 is used to determine which type of storage media 3 operated according to a detecting signal 101 is sent by the storage media connecting unit 200 to control the data pin switching unit 210 and switch the data buses to the storage media interface 30 corresponded to the storage media 3 so as to transmit data signals 102. Besides, if the micro processing unit 100 has identified a storage media 3 and transmitting data, the micro processing unit 100 outputs an indicating message to notify the processor base system 2 when another detecting signal 101 is produced when the storage media 3 inserted into the corresponding storage media interfaces 30.

In addition, the controller 10 further comprises a system interface 300 and a memory unit 400. The system interface 300 is electrically connected with the memory unit 400 and the processor base system 2, and is used to covert serial data. The memory unit 400 further comprises a data buffer region 410 and a software program region 420. The data buffer region 410 can be a random access memory (RAM) for buffing the data transmitted between the processor base system 2 and the storage media 3, and the software program region 420 can be a read-only memory (ROM) for storing a parallel software program for the micro processing unit 100 operating.

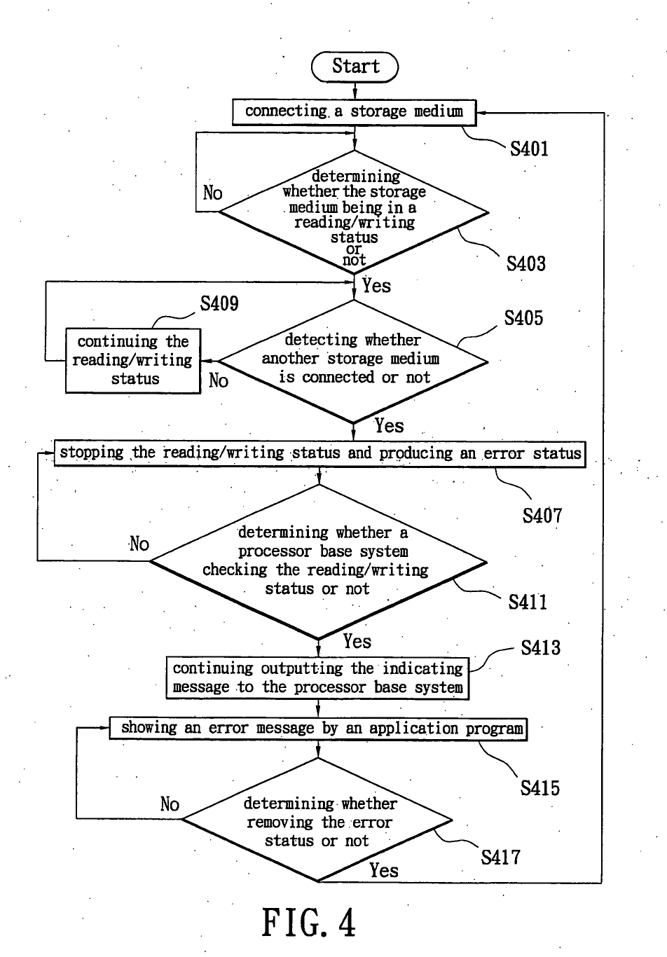

Reference is shown as in FIG. 4, which is a flowchart of an operating method of a silicon storage apparatus according to the present invention. An operating method of a silicon storage apparatus is adapted to a processor base system and comprises the steps: connecting a storage medium 3 via a storage media interface 30 by the silicon storage device 1 (S401), and switching a data transmission channel to the storage medium 3 according to a detecting signal 101 is produced by the storage media 3; next, determining whether the storage medium 3 is in a reading/writing status or not (S403); next, detecting whether another storage medium 3 is connected to the silicon storage apparatus 1 or not (S405) if the storage medium is in a reading/writing status; next, continuing the step (S403) if the storage medium isn't in a reading/writing status; next, stopping the reading/writing status and outputting an indicating message to the processor base system (S407) if another storage medium 3 is connected to the silicon storage apparatus 1; next, continuing the reading/writing status (S409) and executing the step (S405) until finishing the data transmission between the silicon storage apparatus 1 and the processor base system 2 if only one storage medium 3 is connected to the silicon storage apparatus 1.

After the step (S407), further producing an error message and determining whether the processor base system 2 checking the reading/writing status or not (S411), and continuing outputting the indicating message to the processor base system 2 (S413) if the processor base system 2 checks the reading/writing status; next, showing an error message by an application program (S415) when the processor base system 2 identifies the indicating message to remind the users of relative error information; next, determining whether removing the error status by the silicon storage device 1 or not (S417) and removing the error status until determining just only one storage medium 3 inserted in the silicon storage apparatus 1 so as to execute the step (S401); next, continuing to show the error message by the processor base system 2 if the error status isn't removed by the silicon storage device 1. In addition, executing the step (S407) to stop the reading/writing status if the processor base system 2 hasn't checked the reading/writing status to the storage media 3 yet.

It follows from what has been said that not only to reduce effectively whole size of the silicon storage apparatus 1 to carry conveniently and use commodiously but also to reduce substantially size of the chips of the controller 10 to save packaging costs so as to promote easily development, maintenance of the silicon storage apparatus 1.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A silicon storage apparatus is adapted to a processor base system, comprising:
a plurality of storage media interfaces separately used to contain and connect a storage medium; and
a controller electrically connected with the storage media interfaces for providing a data transmission channel to the storage media according to a detecting signal, and outputting an indicating message to the processor base system when another detecting signal is produced.

2. The silicon storage apparatus as claimed in claim 1, wherein the storage media interfaces are slot connectors for various memory cards or all-in-one slot connectors.

3. The silicon storage apparatus as claimed in claim 1, wherein the detecting signal is produced when the storage media is inserted into the corresponding storage media interfaces.

4. The silicon storage apparatus as claimed in claim 1, further comprising:
a transmission interface electrically connected with the controller and used to transmit data between the silicon storage apparatus and the processor base system.

5. The silicon storage apparatus as claimed in claim 4, wherein the transmission interface is a USB interface, PC Card interface, PCI interface, PCI-e interface, IEEE 1394 interface, Ethernet interface, IDE interface, SATA interface, SCSI interface, Bluetooth interface, or Infrared interface.

6. The silicon storage apparatus as claimed in claim 1, wherein the processor base system builds an application program therein to show an error message for the indicating message.

7. A controller for a silicon storage apparatus electrically connected between a processor base system and a plurality of storage media interfaces, and the storage media interfaces separately used to contain and connect a storage medium, comprising:
a storage media connecting unit used to provide a control bus to connect with the storage media interfaces, and further comprising:
a data pin switching unit used to provide data buses for the storage media operating; and
a micro processing unit used to control the data pin switching unit to switch the data buses to the storage media according to a detecting signal, and outputting an indicating message to the processor base system when another detecting signal is produced.

8. The controller for the silicon storage apparatus as claimed in claim 7, wherein the storage media interfaces are slot connectors for various memory cards or all-in-one slot connectors.

9. The controller for the silicon storage as claimed in claim 7, wherein the detecting signal is produced when the storage media is inserted into the corresponding storage media interfaces.

10. The controller for the silicon storage as claimed in claim 7, further comprising:
a memory unit; and
a system interface electrically connected between the memory unit and the processor base system for converting serial data.

11. The controller for the silicon storage as claimed in claim 10, wherein the memory unit further comprises:
a data buffer region used to buff the data transmitted between the processor base system and the storage media; and
a software program region used to store a parallel software program for the micro processing unit operating.

12. The controller of the silicon storage as claimed in claim 11, wherein the data buffer region is a random access memory (RAM) and the software program region is a read-only memory (ROM).

13. An operating method of a silicon storage apparatus adapted to a processor base system, comprising the steps:
connecting a storage medium and switching a data transmission channel to the storage medium;
determining whether the storage medium being in a reading/writing status or not;
detecting whether another storage medium being connected to the silicon storage apparatus or not if the storage medium is in a reading/writing status;
stopping the reading/writing status and outputting an indicating message to the processor base system if another storage medium is connected to the silicon storage apparatus.

14. The operating method of the silicon storage apparatus as claimed in claim 13, the storage media interfaces are slot connectors for various memory cards or all-in-one slot connectors.

15. The operating method of the silicon storage apparatus as claimed in claim 13, further continuing the reading/writing status and detecting whether another storage medium being connected to the silicon storage apparatus or not if another storage medium isn't connected to the silicon storage apparatus.

16. The operating method of the silicon storage apparatus as claimed in claim 13, further producing an error status and determining whether the processor base system checking the reading/writing status or not when stopping the reading/writing status, and continuing outputting the indicating message to the processor base system if the processor base system checks the reading/writing status.

17. The operating method of the silicon storage apparatus as claimed in claim 16, further comprising:
determining whether removing the error status or not so as to operate the silicon storage apparatus and the storage media.

18. The operating method of the silicon storage apparatus as claimed in claim 13, further showing an error message by an application program when the processor base system identifies the indicating message.
